(19) United States
(12) Patent Application Publication
(10) Pub. No.: US 2016/0072859 A1
(43) Pub. Date: Mar. 10, 2016

(54) METHODS FOR SHARING APPLICATIONS AND APPARATUSES USING THE SAME

(71) Applicant: Wistron Corp., New Taipei City (TW)

(72) Inventors: Pen-Tai MIAO, New Taipei City (TW); Ping-Hung CHEN, New Taipei City (TW); Fang-Wen LIAO, New Taipei City (TW)

(21) Appl. No.: 14/547,436

(22) Filed: Nov. 19, 2014

(30) Foreign Application Priority Data
Sep. 5, 2014 (TW) 103130717

(51) Int. Cl. H04L 29/06; H04L 29/08

(52) U.S. Cl. CPC H04L 65/403; H04L 67/025; H04L 67/141

(57) ABSTRACT

An embodiment of the invention introduces a method for sharing applications, executed by a processing unit of a sharing apparatus, which contains at least the following steps. Application-sharing information is sent to a control node, wherein the application-sharing information regarding an application to be shared and a control-filtering policy of the application, thereby enabling the control node to search sharing apparatuses capable of providing services for a requesting apparatus and determine whether to transfer a control signal to the sharing apparatus according to the application-sharing information.

### CROSS REFERENCE TO RELATED APPLICATIONS

This Application claims priority of Taiwan Patent Application No. 103130717, filed on Sep. 5, 2014, the entirety of which is incorporated by reference herein.

### BACKGROUND

1. Technical Field

The present invention relates to screencasting, and in particular to methods for sharing applications and apparatuses using the same.

2. Description of the Related Art

Screen-sharing enables wired or wireless delivery of screen images to or from desktop computers, tablet computers, mobile phones, and other devices. It allows users to, for example, duplicate a display from a desktop computer onto two or more mobile phones, or duplicate displays from two or more mobile phones on the display device of a desktop computer. It also allows users to, for example, operate an application run on a mobile phone through a desktop computer, or operate an application run on a desktop computer through a mobile phone. However, the typical screen-sharing does not support central application management to assist users with selecting one computer apparatus (such as a desktop computer, a notebook computer, a tablet computer, a mobile phone, etc.) and remotely operating an application running on the selected computer apparatus through a user terminal. Thus, it is desirable to have methods for sharing applications and apparatuses using the same to address the aforementioned drawbacks.

### BRIEF SUMMARY

An embodiment of the invention introduces a method for sharing applications, executed by a processing unit of a sharing apparatus, which contains at least the following steps. Application-sharing information is sent to a control node, wherein the application-sharing information comprises an application to be shared and a control-filtering policy of the application, thereby enabling the control node to search sharing apparatuses capable of providing services for a requesting apparatus and determine whether to transfer a control signal to the sharing apparatus according to the application-sharing information.

An embodiment of the invention introduces another method for sharing applications, executed by a processing unit of a control node, which contains at least the following steps. An application request requesting an application is received from a requesting apparatus. It is determined whether any sharing apparatus is capable of providing the application according to application-sharing information, wherein the application-sharing information comprises an application list provided by sharing apparatuses. When the total number of sharing apparatuses capable of providing the application exceeds one, one sharing apparatus is chosen to provide the application to the requesting apparatus according to the workloads of the sharing apparatuses capable of providing the application. An outcome is replied to the requesting apparatus.

An embodiment of the invention introduces still another method for sharing applications, executed by a processing unit of a control node, which contains at least the following steps. A control signal is received from a requesting apparatus to control an application running in a serving apparatus. It is determined whether the control signal is allowed to control the application running in the serving apparatus according to a control-filtering policy. When the control signal is allowed to control the application running in the serving apparatus, the control signal is transferred to the serving apparatus.

An embodiment of the invention introduces an apparatus for sharing applications, operating as a sharing apparatus, which contains at least a communications interface and a processing unit. The processing unit, coupled to the communications interface, sends application-sharing information to a control node via the communications interface, wherein the application-sharing information comprises an application to be shared and a control-filtering policy of the application, thereby enabling the control node to search sharing apparatuses capable of providing services for a requesting apparatus and determine whether to transfer a control signal to the sharing apparatus according to the application-sharing information.

An embodiment of the invention introduces another apparatus for sharing applications, operating as a control node, which contains at least a communications interface, a storage device and a processing unit. The storage device stores application-sharing information comprising an application list provided by sharing apparatuses. The processing unit, coupled to the communications interface and the storage device, receives an application request requesting an application from a requesting apparatus via the communications interface and determines whether any sharing apparatus is capable of providing the application according to the application-sharing information. When the total number of sharing apparatuses capable of providing the application exceeds one, the processing unit chooses one sharing apparatus to provide the application to the requesting apparatus according to the workloads of the sharing apparatuses capable of providing the application and replies with an outcome to the requesting apparatus via the communications interface.

An embodiment of the invention introduces still another apparatus for sharing applications, operating as a control node, which contains at least a communications interface, a storage device and a processing unit. The storage device stores a control-filtering policy. The processing unit, coupled to the communications interface and the storage device, receives a control signal from a requesting apparatus to control an application running in a serving apparatus via the communications interface and determines whether the control signal is allowed to control the application running in the serving apparatus according to a control-filtering policy. When the control signal is allowed to control the application running in the serving apparatus, the processing unit transfers the control signal to the serving apparatus via the communications interface.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 illustrates the system architecture for sharing applications according to an embodiment of the invention;

FIG. 2 is the system architecture of an electronic device according to an embodiment of the invention;

FIG. 3 is a flowchart illustrating a method for registering applications according to an embodiment of the invention;

FIG. 4 is a flowchart illustrating a method for requesting an application according to an embodiment of the invention;

FIG. 5 is a flowchart illustrating a method for controlling the sharing of an application according to an embodiment of the invention;

FIG. 6 is a flowchart illustrating a method for sharing an application according to an embodiment of the invention;

FIG. 7 is a flowchart illustrating a method for transferring a control signal according to an embodiment of the invention; and

FIG. 8 is a diagram illustrating the format of a UIBC (User Input Back Channel) message according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

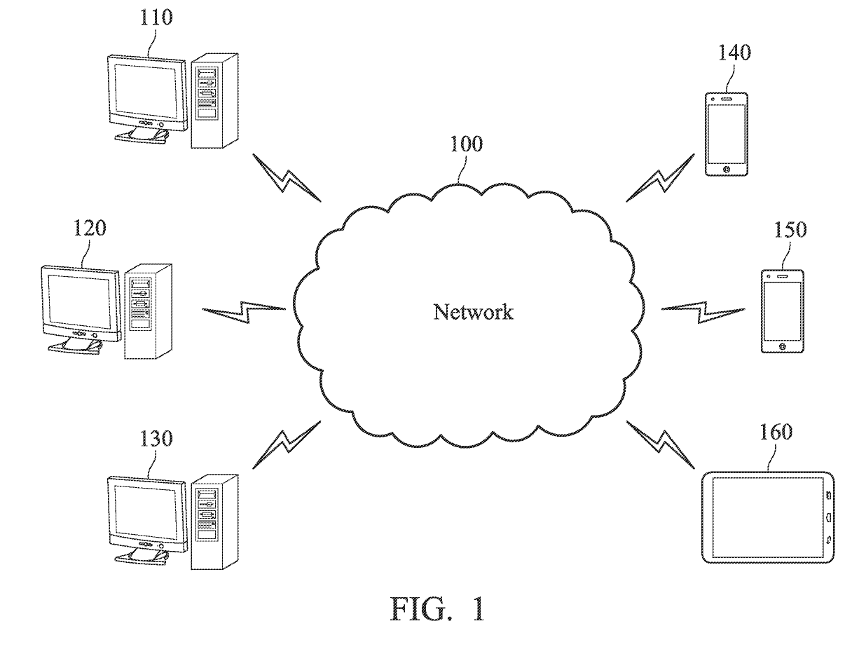

Embodiments of the invention are operated in the screen-sharing system. FIG. 1 illustrates the system architecture for sharing applications according to an embodiment of the invention, containing desktop computers 110, 120 and 130, mobile phones 140 and 150, and a tablet computer 160. Each of the desktop computers 110 to 130 may contain a main unit, a display device and a keyboard. Either the mobile phone 140, 150 or the tablet computer 160 includes a display device. The display device is equipped with a display panel, such as a TFT-LCD (Thin film transistor liquid-crystal display) panel, or an OLED (Organic Light-Emitting Diode) panel, to display input letters, alphanumeric characters and symbols, dragged paths, drawings, or screens provided by an application for the user to view. The desktop computer 110 operates as a control node of a screen-sharing system, and the desktop computers 120 and 130, the mobile phones 140 and 150, and the tablet computer 160 may employ a wireless communications technology, such as Wi-Fi Connect®, Bluetooth®, etc., to connect to the desktop computer 130. The following may refer, if required, the desktop computers 120 and 130, the mobile phones 140 and 150, and the tablet computer 160 to as computer apparatuses. Although a computer apparatus is shown in the embodiments as a desktop computer, a mobile phone or a tablet computer, it should be understood that alternative embodiments are contemplated, such as a notebook computer, etc. The control node 110 may record applications to be shared, which are run on the desktop computers 120 and 130, the mobile phones 140 and 150, and the tablet computer 160, and control-filtering policies. Applications include, without limitation, a browser, a multimedia player, a word-processing program, a spreadsheet program, a presentation program, etc. After receiving an application request from any of the desktop computers 120 and 130, the mobile phones 140 and 150, and the tablet computer 160 (referred to as a requesting apparatus in the following), the control node 110 may search computer apparatuses capable of providing the requesting service, determine one (referred to as a serving apparatus) according to workloads of the capable computer apparatuses, and reply with information of the serving apparatus to the requesting apparatus, thereby enabling the requesting apparatus to establish a direct connection with the serving apparatus, or obtain a screencasting from the serving apparatus and control the serving apparatus remotely via the control node 110. When the control node 110 is used as an intermediate apparatus, the serving apparatus may launch the requested application and use a screencasting technology, such as the Miracast®, etc., to duplicate a displayed application window onto a display unit of the control node 110 (meanwhile, the serving apparatus is referred to as a screen-sharing source and the control node 110 is referred to as a screen-sharing receiver), and the control node 110 may use a screencasting technology to duplicate the displayed application window onto a display unit of the requesting apparatus (meanwhile, the control node 110 is referred to as a screen-sharing source and the requesting apparatus is referred to as a screen-sharing receiver). It should be understood that the control node 110 can act as a screen-sharing source and a screen-sharing receiver at the same time. Moreover, the requesting apparatus may be remotely allowed to manipulate the application run on the serving apparatus. The requesting apparatus may send a control signal to the serving apparatus via the control node 110, such as a click or a double-click at a specific location of the application window, a drag from one location to another, etc. After operating the application according to the received control signal and refreshing the application window, the serving apparatus may duplicate the updated application window onto the display unit of the requesting apparatus via the control node 110. The control node 110 may check the control-filtering policy of the serving apparatus and discard disallowed control signals from transferring to the serving apparatus. The connection between the screen-sharing source and receiver is not limited to wireless communications; it is also feasible to connect the two with wired cables, and the invention should not be limited thereto.

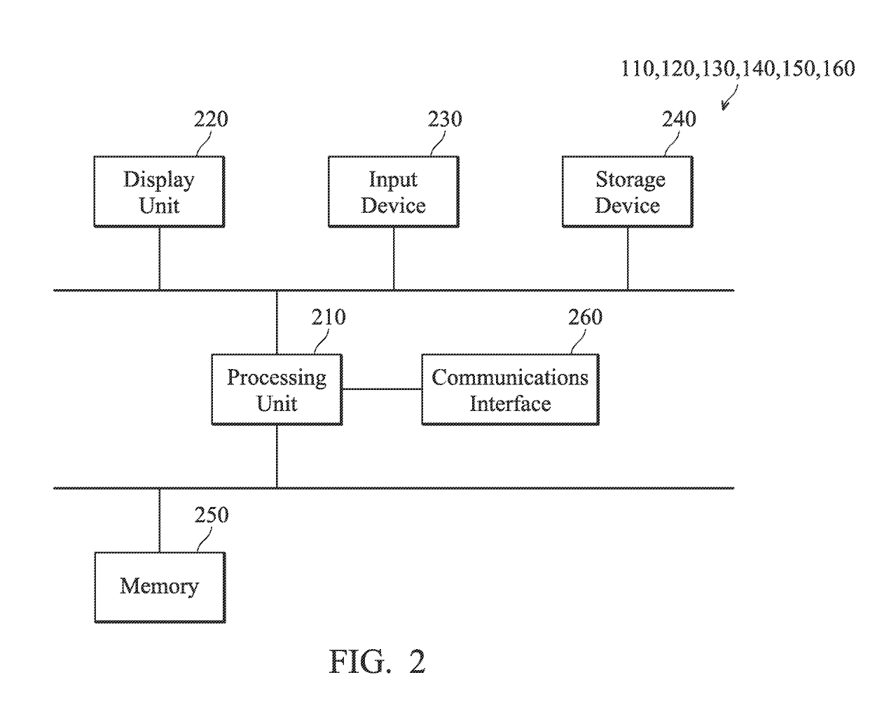

FIG. 2 is the system architecture of an electronic device according to an embodiment of the invention. The system architecture may be practiced in any of the desktop computers 110, 120 and 130, the mobile phones 140 and 150, and the tablet computer 160, or another electronic device with a computation capability. A processing unit 210 can be implemented in numerous ways, such as with dedicated hardware, or with general-purpose hardware (e.g., a single processor, multiple processors or graphics processing units capable of parallel computations, etc.) that is programmed using microcode or software instructions to perform the functions recited herein. The system architecture further includes a memory 250 for storing necessary data in execution, such as variables, data tables, playlists, etc., and a storage unit 240 for storing a wide range of electronic files, such as Web pages, digital documents, video files, audio files, etc. A communications interface 260 is included in the system architecture and the processing unit 210 can thereby communicate with another electronic device. The communications interface 260 may be a wireless telecommunications module, a LAN (Local Area Network) communications module, a WLAN (Wireless Local Area Network), or any combination thereof. The wireless telecommunications module may have modems supporting arbitrary combinations of the 2G, 3G, 4G and the higher-generation technology. The system architecture further includes one or more input devices 230 to receive user input, such as a keyboard, a mouse, a touch panel, etc. A user may press hard keys on the keyboard to input characters, control a mouse pointer on a display by operating the mouse, or control an executed application with one or more gestures made on the touch panel. The gestures include, but are not limited to, a single-click, a double-click, a single-finger drag, and a multiple finger drag. A display unit 220 may include a display panel, such as a TFT-LCD (Thin film transistor liquid-crystal display) panel or an OLED (Organic Light-Emitting Diode) panel, to display input letters, alphanumeric characters, symbols, dragged paths, drawings, or screens provided by an application for the user to view.

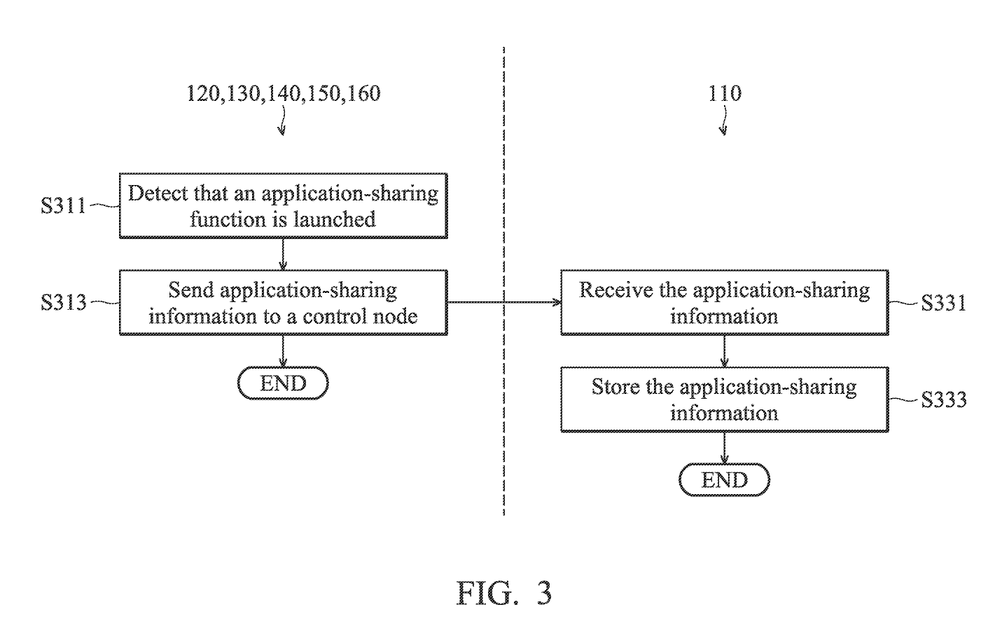

In order for the control node 110 to handle applications and control-filtering policies, which are provided by the computer apparatuses, an embodiment of the invention introduces a method for registering necessary information after the computer apparatuses launch application-sharing functions. FIG. 3 is a flowchart illustrating a method for registering applications, performed by the processing unit 210 of any of the desktop computers 120 and 130, the mobile phones 140 and 150 and the tablet computer 160 (referred to as a sharing apparatus in the following), and the processing unit 210 of the desktop computer 110 (referred to as a control node in the following) in coordination according to an embodiment of the invention. After detecting that an application-sharing function is launched (step S311), the processing unit 210 of the sharing apparatus 120, 130, 140, 150 or 160 sends application-sharing information to the control node 110 via the communications interface 260 thereof (step S313), where the application-sharing information includes, but is not limited to, a network address thereof, applications to be shared, control-filtering policies and capability of direct connection. In step S313, the application-sharing information may be carried by a formatted message recognized by the sharing apparatuses 120, 130, 140, 150 and 160 and the control node 110. After receiving the application-sharing information via the communications interface 260 of the control node 110 (step S331), the processing unit 210 of the control node 110 stores the application-sharing information in the storage device 240 of the control node 110 (step S333). In step S333, the application-sharing information may be stored in a word-processing file, a spreadsheet file, a database table or another kind of digital file. Exemplary application-sharing information of the sharing apparatus 120 is described in Table 1:

TABLE 1

| | Application | Control-filtering | Direct connection |
|---|---|---|---|
| Network address | code | policy | capability (Yes/No) |
| 192.168.1.120 | A | Prohibiting drag | Yes |
| 192.168.1.120 | B | Prohibiting click | Yes |
| | | and double-click | |

Table 1 describes the network address of the sharing apparatus 120 as “192.168.1.120” and the sharing apparatus 120 has the capability of direct connection and shares two applications “A” and “B”. In addition, the application “A” disallows a remote control of a drag and the application “B” disallows remote controls of a click and a double-click. Exemplary application-sharing information of the sharing apparatus 130 is described in Table 2:

TABLE 2

| | Application | Control-filtering | Direct connection |
|---|---|---|---|
| Network address | code | policy | capability (Yes/No) |
| 192.168.1.130 | B | Prohibiting | No |
| | | double-click | |

Table 2 describes the network address of the sharing apparatus 130 as “192.168.1.130” and the sharing apparatus 130 does not have the capability of direct connection and shares the application “B”. In addition, the application “B” disallows a remote control of a double-click. Exemplary application-sharing information of the sharing apparatus 140 is described in Table 3:

TABLE 3

| | Application | Control-filtering | Direct connection |
|---|---|---|---|
| Network address | code | policy | capability (Yes/No) |
| 192.168.1.140 | C | Prohibiting | No |
| | | double-click | |

Table 3 describes the network address of the sharing apparatus 140 as “192.168.1.140” and the sharing apparatus 140 does not have the capability of direct connection and shares the application “C”. In addition, the application “C” disallows a remote control of a double-click. Exemplary application-sharing information of the sharing apparatus 150 is described in Table 4:

TABLE 4

| | Application | Control-filtering | Direct connection |
|---|---|---|---|
| Network address | code | policy | capability (Yes/No) |
| 192.168.1.150 | D | Disabling remote | Yes |
| | | control | |

Table 4 describes the network address of the sharing apparatus 150 as “192.168.1.150” and the sharing apparatus 150 has the capability of direct connection and shares the application “D”. In addition, the application “D” disallows all remote controls. Exemplary application-sharing information of the sharing apparatus 160 is described in Table 5:

TABLE 5

| | Application | Control-filtering | Direct connection |
|---|---|---|---|
| Network address | code | policy | capability (Yes/No) |
| 192.168.1.160 | E | Prohibiting drag | Yes |

Table 5 describes the network address of the sharing apparatus 160 as “192.168.1.160” and the sharing apparatus 160 does not have the capability of direct connection and shares the application “E”. In addition, the application “D” disallows a remote control of a drag. Although the exemplary control-filtering policies described in Tables 1 to 5 disallow all or particular kinds of control signals, those skilled in the art may append limited regions (x₀, y₀)˜(x₁,y₁) to the control-filtering policies, thereby enabling the prohibited control signals from being applied to the limited regions of the application window.

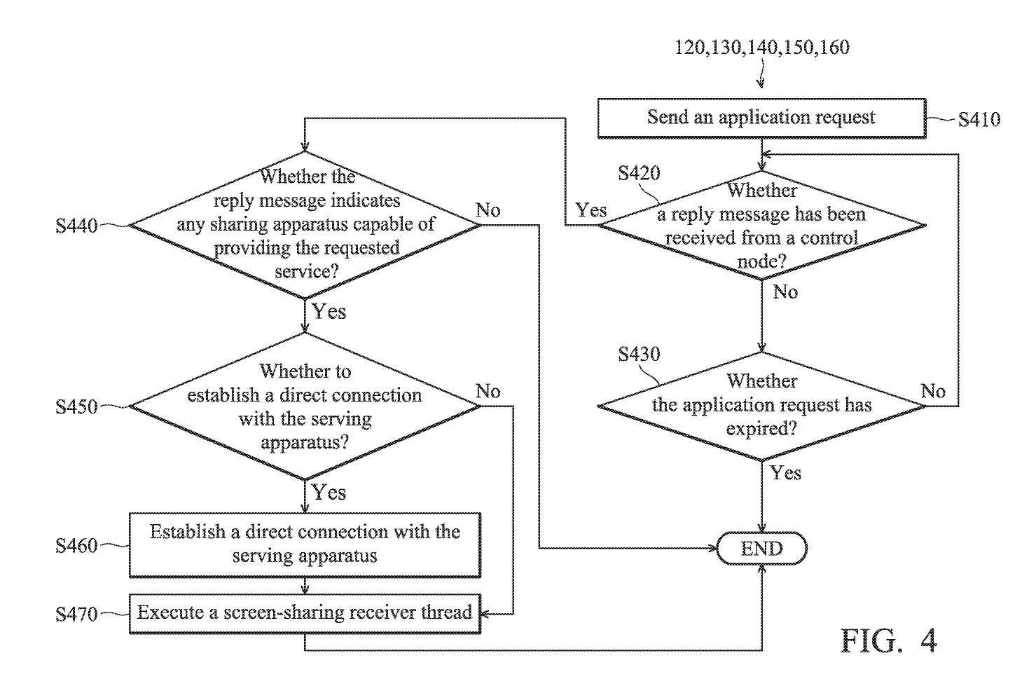

FIG. 4 is a flowchart illustrating a method for requesting an application, performed by the processing unit 210 of any of the desktop computers 120 and 130, the mobile phones 140 and 150 and the tablet computer 160 (referred to as a requesting apparatus in the following) according to an embodiment of the invention. Users may select an application to be used and press a submit button via a MMI (Man-Machine Interface) to start the method. After sending an application request to the control node 110 via the communications interface 260 of the requesting apparatus 120, 130, 140, 150 or 160 (step S410), the processing unit 210 of the requesting apparatus periodically performs a detection loop to determine whether a reply message has been received from the control node 110 (step S420). When no reply message has been received from the control node 110 (the “No” path of step S420), it is further determined whether the application request has expired (step S430). When the application request has expired (the “Yes” path of step S430), a request failure message may be prompted to the users via the MMI and the whole process ends; otherwise, the process proceeds to the next detection run (step S420). When a reply message has been received from the control node 110 (the “Yes” path of step S420), it is further determined whether the reply message indicates any sharing apparatus capable of providing the requested service (step S440). When the reply message indicates no sharing apparatus can provide the requested service (the “No” path of step S440), a message indicating that no sharing apparatus is available is prompted to the users via the MMI and the whole process ends. When the reply message indicates a sharing apparatus capable of providing the requested service (referred to as a serving apparatus in the following) (the “Yes” path of step S440), it is further determined whether to establish a direct connection with the serving apparatus (step S450). When the reply message indicates that the serving apparatus has the capability of direct connection and the requesting apparatus also has the capability of direct connection (the “Yes” path of step S450), a direct connection is established with the serving apparatus (step S460) and a screen-sharing receiver thread is executed (step S470). In step S450, the processing unit 210 of the requesting apparatus 120, 130, 140, 150 or 160 may establish the direct connection with the serving apparatus by a well-known protocol, such as Wi-Fi Direct, Wi-Fi P2P, Bluetooth, etc., via the communications interface 260 of the requesting apparatus 120, 130, 140, 150 or 160. When the reply message indicates that the serving apparatus has no capability of direct connection or the requesting apparatus has no capability of direct connection (the “No” path of step S450), a screen-sharing receiver thread is executed (step S470). It should be noted in step S470 that the screen-sharing receiver thread receives image data from the serving apparatus when the requesting apparatus establishes a direct connection with the serving apparatus, and the screen-sharing receiver thread receives image data from the control node 110 when the requesting apparatus fails to establish a direct connection with the serving apparatus. Specifically, when the screen-sharing receiver thread is executed, the processing unit 210 of the requesting apparatus 120, 130, 140, 150 or 160 may periodically receive image data via the communications interface 260 thereof, decode the image data and render the decoded results on the display unit 220 thereof.

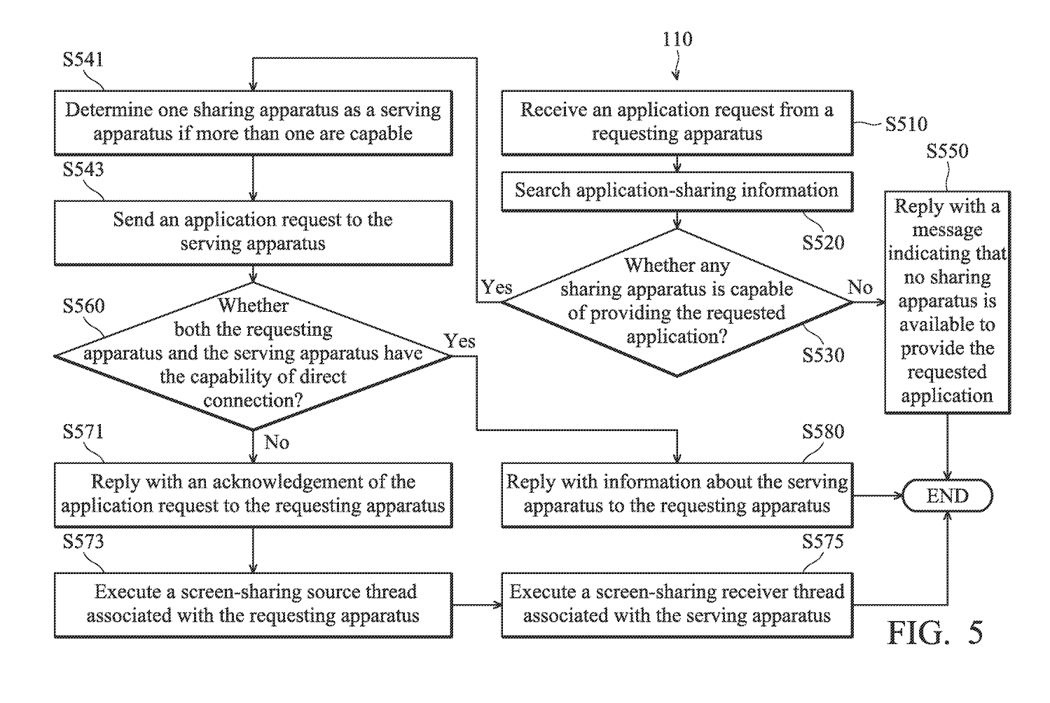

FIG. 5 is a flowchart illustrating a method for controlling the sharing of an application, performed by the processing unit 210 of the control node 110, according to an embodiment of the invention. Users may activate an application-sharing console via a MMI to start the method. After receiving an application request from the requesting apparatus via the communications interface 260 of the control node 110 (step S510), application-sharing information is searched from the storage device 240 of the control node 110 (step S520), and it is determined whether any sharing apparatus is capable of providing the requested application according to the application-sharing information (step S530). When no sharing apparatus is capable of providing the requested application (the “No” path of step S530), a message indicating that no sharing apparatus is available to provide the requested application is replied to the requesting apparatus (step S550) and the whole process ends. For example, since an application request indicates the need for an application “M”, the processing unit 210 may know no sharing apparatus providing the services of application “M” according to the application-sharing information as shown in Tables 1 to 5. When a sharing apparatus is capable of providing the requested application (the “Yes” path of step S530), one sharing apparatus (referred to as a serving apparatus in the following) is chosen if more than one are capable (step S541), and an application request including an application code associated with the application to be launched is sent to the serving apparatus (step S543). In step S541, the processing unit 210 may determine one sharing apparatus to provide the service according to workloads of the searched sharing apparatuses. For example, since the application request indicates a need of the application “B”, the processing unit 210 may know the sharing apparatuses 120 and 130 are capable of providing services of the application “B” according to the application-sharing information as shown in Tables 1 to 5. Assume that the sharing apparatus 120 is providing the service of the application “B” to another electronic apparatus: The processing unit 210 determines the sharing apparatus 130 to provide the service of the application “B” to the requesting apparatus. Then, it is determined whether both the requesting apparatus and the serving apparatus have the capability of direct connection (step S560). If so, then information about the serving apparatus is replied to the requesting apparatus (step S580), enabling the requesting apparatus to establish a direct connection with the serving apparatus and remotely use the application shared by the serving apparatus. Otherwise, an acknowledgement of the application request is replied to the requesting apparatus (step S571), a screen-sharing source thread associated with the requesting apparatus is executed (step S573), a screen-sharing receiver thread associated with the serving apparatus is executed (step S575), enabling the processing unit 210 of the control node 110 to transfer the image data of the serving apparatus to the requesting apparatus via the communications interface 260 of the control node 110 and transfer control signals from the requesting apparatus to the serving apparatus. In steps S571 and S580, the processing unit 210 of the control node 110 may record information indicating that the application of the serving apparatus is currently being used by the requesting apparatus in the storage device 240 or the memory 250 of the control node 110. Specifically, the processing unit 210 of the control node 110 may periodically receive image data from the serving apparatus via the communications interface 260 of the control node 110 when the screen-sharing receiver thread is executed, and periodically transmit the image data to the requesting apparatus via the communications interface 260 of the control node 110 when the screen-sharing source thread is executed.

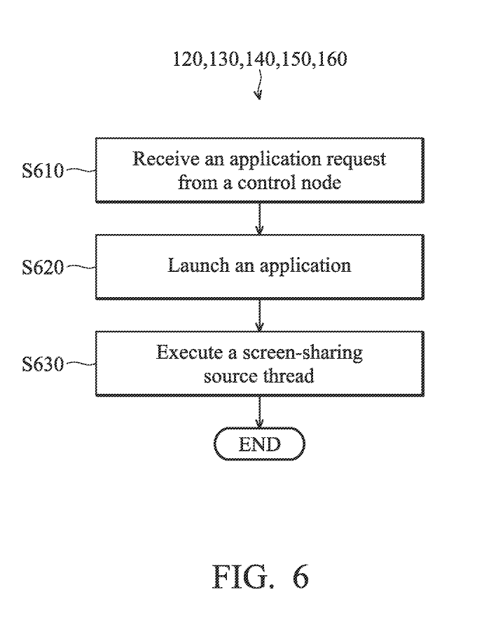

FIG. 6 is a flowchart illustrating a method for sharing an application, performed by the processing unit 210 of any of the desktop computers 120 and 130, the mobile phones 140 and 150 and the tablet computer 160 (referred to as a serving apparatus in the following) according to an embodiment of the invention. After receiving an application request from the control node 110 (step S610), the requested application is launched to display an application window on the display unit 220 of the serving apparatus 120, 130, 140, 150 or 160 (step S620), and a screen-sharing source thread is executed (step S630), enabling the displayed application window to be transmitted to the control node 110 or the requesting apparatus. Specifically, when the screen-sharing source thread is executed, the processing unit 210 of the serving apparatus 120, 130, 140, 150 or 160 may periodically (e.g. 40 frames per second) obtain image data displayed on the display unit 220 of the serving apparatus from a frame buffer, and transmit the obtained image data to the control node 110 or the requesting apparatus via the communications interface 260 of the serving apparatus.

The following provides a scenario to further explain the flowcharts of FIGS. 4 to 6. Assume the application-sharing information of sharing apparatuses 120 to 160 is that shown in Tables 1 to 5. After receiving a request for application “B” from the requesting apparatus 150 (steps S410 and S510), the processing unit 210 of the control node 110 searches the application-sharing information as shown in Tables 1 to 5 from the storage device 240 of the control node 110 (step S520). Next, the processing unit 210 of the control node 110 knows that the sharing apparatuses 120 and 130 are capable of providing the services of application “B” according to the application-sharing information, and chooses the sharing apparatus 130 (referred to as the serving apparatus) to provide the service of the application “B” to the requesting apparatus 150 based on the workloads of the sharing apparatuses 120 and 130 (steps S530 and S541) and sends an application request to the serving apparatus 130 (step S543). After receiving the application request (step S610), the processing unit 210 of the serving apparatus 130 launches the application “B” (step S620) and executes a screen-sharing source thread (step S630), enabling an application window displayed on the display unit 220 of the serving apparatus 130 to be transmitted to the control node 110. After determining that the requesting apparatus 150 has failed to establish a direct connection with the serving apparatus 130 by referring to Tables 2 and 4 (step S560), the processing unit 210 of the control node 110 sends an acknowledgment for the application request to the requesting apparatus 150 (step S571), executes a screen-sharing source thread associated with the requesting apparatus 150 (step S573) and executes a screen-sharing receiver thread associated with the serving apparatus 130 (step S575), enabling the processing unit 210 of the control node 110 to transfer the application window of the serving apparatus 130 to the requesting apparatus 150. After receiving the acknowledgement of the application request, the processing unit 210 of the requesting apparatus 150 executes a screen-sharing receiver thread (step S470), enabling the processing unit 210 of the requesting apparatus 150 to receive the application window from the control node 110.

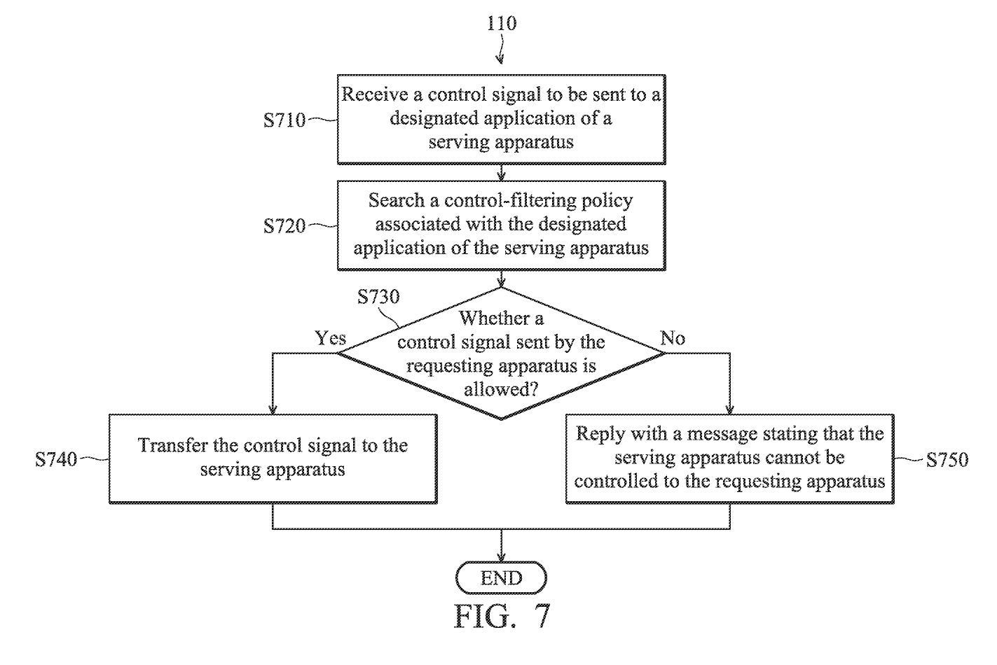

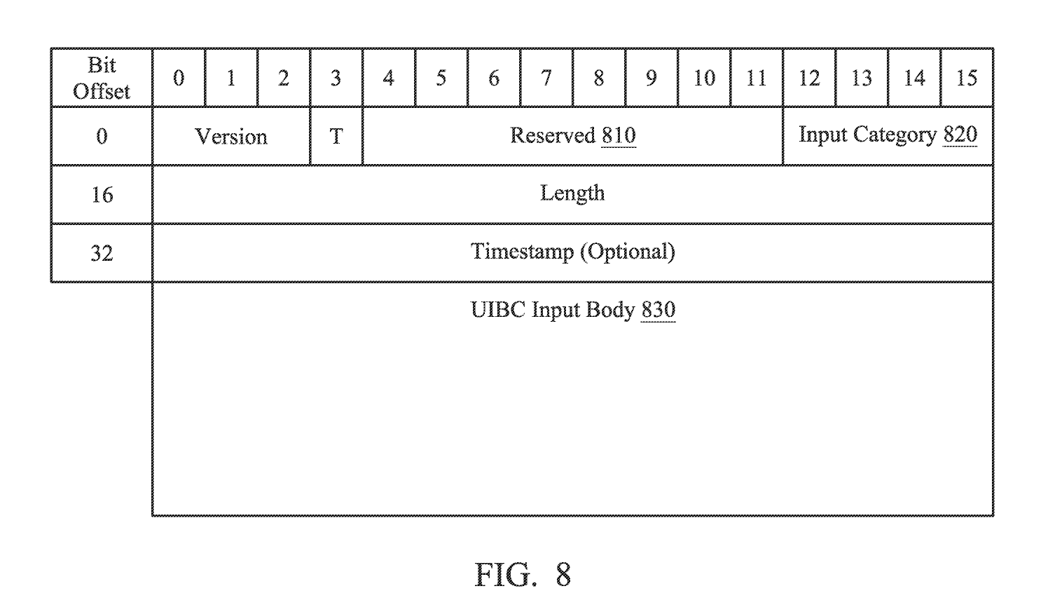

FIG. 7 is a flowchart illustrating a method for transferring a control signal according to an embodiment of the invention. The method is performed by the processing unit 210 of the control node 110 when the requesting apparatus needs the control node to transfer a control signal to the serving apparatus. After receiving a control signal to be sent to a designated application of the serving apparatus, such as a click, a double-click, a drag etc. (step S710), the processing unit 210 of the control node 110 searches a control-filtering policy associated with the designated application of the serving apparatus (step S720). FIG. 8 is a diagram illustrating the format of a UIBC (User Input Back Channel) message according to an embodiment of the invention. In the example illustrated in step S710, the requesting apparatus may encapsulate the control signal in the UIBC input body field 830 of a UIBC message. However, the processing unit 210 of the control node 110 needs to parse the content of the UIBC input body field 830 to obtain the control signal. Another example illustrated in step S710, the requesting apparatus may encapsulate the control signal in the input category field 820 of a UIBC message. Since the values 0 and 1 are used in the Miracast® specification, the requesting apparatus may use a value ranging from 2 to 15 to indicate a specific control signal. For example, the requesting apparatus may use 3, 4 and 5 to indicate a click, a double-click and a drag, respectively. The processing unit 210 of the control node 110 may know the control signal to be transmitted to the serving apparatus by checking the value of the input category field 820, where the inspection is faster than parsing the UIBC input body field 30. Still another example illustrated in step S710, the requesting apparatus may encapsulate the control signal in the reserved field 810 of a UIBC message. The requesting apparatus may treat 8 bits of the reserved field 810 as a bitmap. For example, the 4^{th} bit of “1” indicates a click, the 5^{th} bit of “1” indicates a double-click and the 6^{th} bit of “1” indicates a drag. The processing unit 210 of the control node 110 may know the control signal to be transmitted to the serving apparatus by checking the bitmap of the reserved field 810, where the inspection is faster than parsing the UIBC input body field 830. Details of the control-filtering policy recited in step S720 may refer to the description of Tables 1 to 5. Next, it is determined whether the control signal sent by the requesting apparatus is allowed according to the control-filtering policy associated with the designated application of the serving apparatus (step S730). In step S730, the processing unit 210 of the control node 110 further parses the content of the UIBC input body field 830 to obtain one or more positions associated with the control signal if the control-filtering policy for the control signal is only applied to a particular limited region, and determines whether the position(s) fall(s) within the limited region. If so, the control signal is transferred to the serving apparatus (step S740); otherwise, a message stating that the serving apparatus cannot be controlled is replied to the requesting apparatus (step S750).

Although the embodiment has been described as having specific elements in FIG. 2, it should be noted that additional elements may be included to achieve better performance without departing from the spirit of the invention. While the process flows described in FIGS. 3 to 7 each include a number of operations that appear to occur in a specific order, it should be apparent that these processes can include more or fewer operations, which can be executed in series or in parallel (e.g., using parallel processors or a multi-threading environment).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for sharing applications, performed by a processing unit of a sharing apparatus, comprising:
sending application-sharing information to a control node, wherein the application-sharing information comprises an application to be shared and a control-filtering policy of the application, thereby enabling the control node to search sharing apparatuses capable of providing services for a requesting apparatus and determine whether to transfer a control signal to the sharing apparatus according to the application-sharing information.

2. The method of claim 1, wherein the application-filtering policy describes a disallowed remote control.

3. The method of claim 1, wherein the application-filtering policy describes a disallowed remote control applying to a limited region in a window of the application.

4. The method of claim 1, wherein the application-sharing information further indicates whether the sharing apparatus has a capability of direct connection, thereby enabling the control node to determine whether to advise the requesting apparatus to establish a direct connection with the sharing apparatus.

5. A method for sharing applications, performed by a processing unit of a control node, comprising:
receiving an application request requesting an application from a requesting apparatus;
determining whether any sharing apparatus is capable of providing the application sharing information comprises an application list provided by a plurality of sharing apparatuses;
when a total number of the sharing apparatuses capable of providing the application exceeds one, choosing one sharing apparatus to provide the application to the requesting apparatus according to workloads of the sharing apparatuses capable of providing the application, wherein the determined sharing apparatus is referred to as a serving apparatus; and
replying with an outcome to the requesting apparatus.

6. The method of claim 5, wherein the application-sharing information comprises direct connection capabilities of the sharing apparatuses, the method comprising:
determining whether a direct connection can be established between the requesting apparatus and the serving apparatus according to the application-sharing information; and
if so, replying with information of the serving apparatus to the requesting apparatus, thereby enabling the requesting apparatus to establish a direct connection with the serving apparatus.

7. The method of claim 6 further comprising:
when determining that a direct connection cannot be established between the requesting apparatus and the serving apparatus, replying with an acknowledgement of the application request to the requesting apparatus;
executing a screen-sharing source thread associated with the requesting apparatus; and
executing a screen-sharing receiver thread associated with the serving apparatus, thereby enabling the processing unit to transfer image data of the serving apparatus to the requesting apparatus and transfer a control signal sent by the requesting apparatus to the serving apparatus.

8. A method for sharing applications, performed by a processing unit of a control node, comprising:
receiving a control signal from a requesting apparatus to control an application running in a serving apparatus;
determining whether the control signal is allowed to control the application running in the serving apparatus according to a control-filtering policy; and
when the control signal is allowed to control the application running in the serving apparatus, transferring the control signal to the serving apparatus.

9. The method of claim 8, further comprising:
when the control signal is not allowed to control the application running in the serving apparatus, replying with a message stating that the serving apparatus cannot be controlled to the requesting apparatus.

10. The method of claim 8, wherein the control signal is a click, a double-click or a drag.

11. The method of claim 10, wherein the control signal is represented by a value of an input category field of a UIBC (User Input Back Channel) message.

12. The method of claim 10, wherein the control signal is represented by a bitmap of a reserved field of a UIBC (User Input Back Channel) message.

13. An apparatus for sharing applications, operating as a sharing apparatus, comprising:
a communications interface; and
a processing unit, coupled to the communications interface, sending application-sharing information to a control node via the communications interface, wherein the application-sharing information comprises an application to be shared and a control-filtering policy of the application, thereby enabling the control node to search sharing apparatuses capable of providing services for a requesting apparatus and determine whether to transfer a control signal to the sharing apparatus according to the application-sharing information.

14. The apparatus of claim 13, wherein the application-filtering policy describes a disallowed remote control.

15. The apparatus of claim 13, wherein the application-filtering policy describes a disallowed remote control applying to a limited region in a window of the application.

16. The apparatus of claim 13, wherein the application-sharing information further indicates whether the sharing apparatus has a capability of direct connection, thereby enabling the control node to determine whether to advise the requesting apparatus to establish a direct connection with the sharing apparatus.

17. An apparatus for sharing applications, operating as a control node, comprising:
a communications interface;
a storage device, storing application-sharing information comprising an application list provided by a plurality of sharing apparatuses; and
a processing unit, coupled to the communications interface and the storage device, receiving an application request requesting an application from a requesting apparatus via the communications interface; determining whether any sharing apparatus is capable of providing the application according to the application-sharing information; when a total number of the sharing apparatuses capable of providing the application exceeds one, choosing one sharing apparatus to provide the application to the requesting apparatus according to workloads of the sharing apparatuses capable of providing the application, wherein the determined sharing apparatus is referred to as a serving apparatus; and replying with an outcome to the requesting apparatus via the communications interface.

18. The apparatus of claim 17, wherein the application-sharing information comprises direct connection capabilities of the sharing apparatuses, and the processing unit determines whether a direct connection can be established between the requesting apparatus and the serving apparatus according to the application-sharing information; and
if so, replies with information of the serving apparatus to the requesting apparatus via the communications interface, thereby enabling the requesting apparatus to establish a direct connection with the serving apparatus.

19. The apparatus of claim 18, wherein when determining that a direct connection cannot be established between the requesting apparatus and the serving apparatus, the processing unit replies with an acknowledgement of the application request to the requesting apparatus via the communications interface; executes a screen-sharing source thread associated with the requesting apparatus; and executes a screen-sharing receiver thread associated with the serving apparatus, thereby enabling the processing unit to transfer image data of the serving apparatus to the requesting apparatus and transfer a control signal sent by the requesting apparatus to the serving apparatus.

20. An apparatus for sharing applications, operating as a control node, comprising:
a communications interface;
a storage device, storing a control-filtering policy; and
a processing unit, coupled to the communications interface and the storage device, receiving a control signal from a requesting apparatus to control an application running in a serving apparatus via the communications interface; determining whether the control signal is allowed to control the application running in the serving apparatus according to a control-filtering policy; and when the control signal is allowed to control the application running in the serving apparatus, transferring the control signal to the serving apparatus via the communications interface.

21. The apparatus of claim 20, wherein when the control signal is not allowed to control the application running in the serving apparatus, the processing unit replies with a message stating that the serving apparatus cannot be controlled to the requesting apparatus via the communications interface.

22. The apparatus of claim 20, wherein the control signal is a click, a double-click or a drag.

23. The apparatus of claim 22, wherein the control signal is represented by a value of an input category field of a UIBC (User Input Back Channel) message.

24. The apparatus of claim 22, wherein the control signal is represented by a bitmap of a reserved field of a UIBC (User Input Back Channel) message.
